(19) United States
(12) Patent Application Publication
(10) Pub. No.: US 2025/0284574 A1
(43) Pub. Date: Sep. 11, 2025

(54) Managing Storage Residency of Messages on Queues

(71) Applicant: International Business Machines Corporation, Armonk, NY (US)

(72) Inventors: Cameron Thomas Doggett, Austin, TX (US); Mark Richard Gambino, Brewster, NY (US); James V. Farmer, Wappingers Falls, NY (US); John Muller, Wappingers Falls, NY (US); Mark David Cooper, Poughkeepsie, NY (US); Leo Giannelli, Brooklyn, NY (US)

(21) Appl. No.: 18/595,594

(22) Filed: Mar. 5, 2024

(51) Int. Cl. G06F 9/54; G06F 11/34

(52) U.S. Cl. CPC G06F 9/546; G06F 11/34

(57) ABSTRACT

Managing message storage residency on queues is provided. An evaluation of usage patterns, factors, and message processing environment data corresponding to each respective queue of a set of queues in main memory is performed. One or more contiguous groups of messages are moved between physical storage mediums by performing at least one of message sweeping and message unsweeping to adjust a size of at least one message region of one or more queues of the set of queues in response to determining that movement of the one or more contiguous groups of messages between the physical storage mediums is needed based on the evaluation.

### BACKGROUND

The disclosure relates generally to message queues and more specifically to managing message storage residency on the message queues.

A message queue is a component of message queueing middleware that enables independent applications and services to exchange information. Message queues store messages (e.g., packets of data that applications generate for other applications to consume) in the order the messages are transmitted until the consuming application can process the messages. The message queue enables messages to wait until the receiving application is ready, so if there is a problem with, for example, the network or consuming application, the messages in the message queue are not lost. In other words, message queues implement an asynchronous communication pattern between two or more applications whereby the transmitting application and the consuming application do not need to interact with the message queue at the same time.

### SUMMARY

According to one illustrative embodiment, a computer-implemented method for managing message storage residency on queues is provided. A computer performs an evaluation of usage patterns, factors, and message processing environment data corresponding to each respective queue of a set of queues in main memory. The computer moves one or more contiguous groups of messages between physical storage mediums by performing at least one of message sweeping and message unsweeping to adjust a size of at least one message region of one or more queues of the set of queues in response to determining that movement of the one or more contiguous groups of messages between the physical storage mediums is needed based on the evaluation. According to other illustrative embodiments, a computer system and computer program product for managing message storage residency on queues are provided.

### BRIEF DESCRIPTION OF THE DRAWINGS

FIG. 1 is a pictorial representation of a computing environment in which illustrative embodiments may be implemented;

FIG. 2 is a diagram illustrating an example of a single message queue in accordance with an illustrative embodiment;

FIG. 3 is a diagram illustrating an example of a computer system with multiple message queues in accordance with an illustrative embodiment;

FIG. 4 is a diagram illustrating an example of a state of the computer system when an application stops processing messages in accordance with an illustrative embodiment;

FIG. 5 is a diagram illustrating an example of a state of the computer system during a remote node outage in accordance with an illustrative embodiment;

FIG. 6 is a diagram illustrating an example of a state of the computer system at a particular point in time during the day in accordance with an illustrative embodiment;

FIG. 7 is a diagram illustrating an example of a state of the computer system at a further point in time during the day in accordance with an illustrative embodiment;

FIG. 8 is a diagram illustrating an example of a state of the computer system at yet a further point in time during the day in accordance with an illustrative embodiment;

FIG. 9 is a diagram illustrating an example of a state of the computer system at yet another further point in time during the day in accordance with an illustrative embodiment;

FIG. 10 is a diagram illustrating an example of a state of the computer system at yet still another further point in time during the day in accordance with an illustrative embodiment;

FIGS. 11A-11C are a flowchart illustrating a process for managing message storage residency on queues in accordance with an illustrative embodiment; and

FIG. 12 is a flowchart illustrating a process for sweeping and unsweeping messages corresponding to queues on a macro scale in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

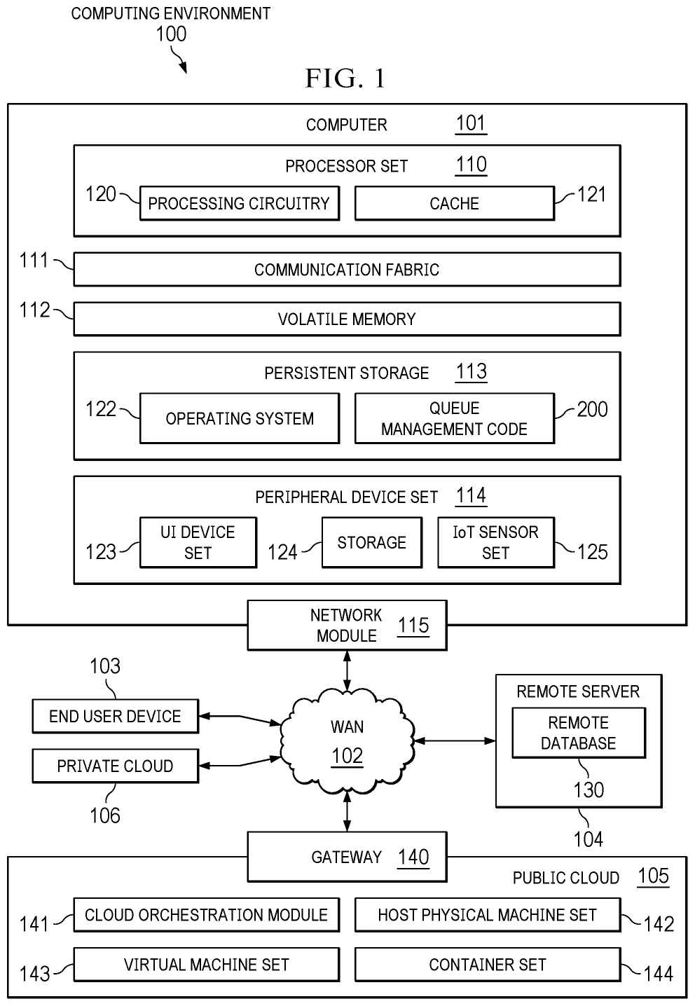

With reference now to the figures, and in particular, with reference to FIG. 1 and FIGS. 3-10, diagrams of data processing environments are provided in which illustrative embodiments may be implemented. It should be appreciated that FIG. 1 and FIGS. 3-10 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as queue management code 200. For example, unlike current message queuing middleware solutions responsible for managing the storage residency of messages, such as, for example, least-recently used (LRU), most-recently used (MRU), clock (second chance), and largest queue first, queue management code 200 examines the application usage patterns of individual queues relative to other queues in order to evaluate which messages on which queues are likely to be needed sooner for retrieval or transmission. By queue management code 200 accurately retaining or restoring messages in queues of main memory shortly ahead of when the messages are needed, queue management code 200 is less likely to cause message thrashing, increased latency, and decreased throughput to occur and harm service level agreements. Queue management code 200 sweeps or remove messages, which are less likely to be needed in the near future, to secondary persistent storage. Queue management code 200 includes a queue state evaluation component, which utilizes both coded rules and machine learning, to enable message sweeping and message unsweeping that is responsive to a broad range of situations, both random and predictable, and adaptable to new situations through data collection and retraining of the machine learning model.

In addition to queue management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and queue management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in queue management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a system administrator who is utilizing the queue management services provided by computer 101), and may take any of the forms discussed above in connection with computer 101. EUD 103 typically receives helpful and useful data from the operations of computer 101. For example, in a hypothetical case where computer 101 is designed to provide a queue management recommendation to the end user, this recommendation would typically be communicated from network module 115 of computer 101 through WAN 102 to EUD 103. In this way, EUD 103 can display, or otherwise present, the queue management recommendation to the end user. In some embodiments, EUD 103 may be a client device, such as thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a queue management recommendation based on historical queue characteristics data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In the domain of message queueing middleware both message volumes and message sizes are trending larger. One property of a message is its persistence or delivery type, which is either persistent (i.e., guaranteed delivery) or nonpersistent (i.e., best effort delivery, but may never be delivered). For performance reasons with high volume queues, current message queuing middleware solutions attempt to keep a copy of persistent messages in main memory and have the only copy of nonpersistent messages in main memory. Under normal conditions, messages are quickly consumed (i.e., removed from a local queue, either consumed by a local application or delivered to a remote node to be consumed by a remote application) soon after the messages are generated and enqueued. In other words, not many messages exist on the queues at any single moment in time. However, if messages are generated faster than the messages are consumed (e.g., the message consumer has an outage, the message consumer cannot process that high a volume of messages, network issues exist, and the like), the number of messages in main memory increases and is constrained by the amount of main memory that is available to the message queuing middleware.

While large memory capacities are currently more accessible and affordable, such large memory capacities only reduce the likelihood of memory exhaustion by increasing the number of messages that can exist in memory of the computer system at a single point in time. Still, it is almost always the case that a computer has a significantly larger amount of non-volatile or persistent storage, such as spinning disk or solid-state, available to it relative to the volatile storage, such as random-access memory (RAM), present on the computer system. For example, a computer system may only have 16 GB of RAM but also have 2 TB of persistent storage. Thus, message queuing middleware should have the capability to move messages in and out of memory and secondary persistent storage (e.g., disk) in order to effectively manage such low-memory scenarios and support a larger number of messages on queues than the physical main memory can accommodate at a single point in time. However, because non-volatile storage is typically substantially slower to access compared to volatile storage, it is equally important to determine which messages are removed from, restored to, and retained in which particular queue of main memory because not having the correct set of messages resident in main memory when needed, either to meet local application demand or to transmit over the network to a remote node, will have a negative impact on throughput, computer system health, and service level agreements.

Many modern, general-purpose operating systems achieve the abstraction of virtualized and almost limitless memory (but still bounded by the secondary persistent storage) from the applications' perspective through memory paging and the process of swapping or sweeping those pages between main memory and secondary storage mediums. While generally effective, paging and page replacement solutions, such as, for example, least-recently used and clock, lack insight into application and middleware- level logic to more accurately predict which pages to retain. Equally challenging is an ability to predict which pages to restore to main memory ahead of application demand. Thus, macro-level page sweeping is inadequate in the context of high-performance message queueing services, especially in the case of large, growing queues with recent main memory references biased toward the end of the queue.

Current solutions that utilize the message queuing middleware to manage its own pool of main memory, while gaining the advantage of additional usage insight into memory paging, may still lead to message thrashing (i.e., sweeping messages from main memory to secondary persistent storage and then quickly unsweeping those same messages back into main memory from secondary persistent storage), increased latency, or reduced throughput when a basic determination is made as to which messages are retained in main memory. For example, sweeping the least-recently used queue, most- recently used queue, or largest queue first, lacks an understanding of the applications' queue usage patterns, which when misunderstood or ignored computationally penalizes applications by sweeping messages to persistent storage that should have been retained in main memory. For example, messages for a given queue are delivered in order, which means that the oldest message on that queue is the one that will be accessed next even though it may have been a long time since the queue containing that message has been referenced.

Similarly, if a queue is large (e.g., containing 50,000 messages or more), and a new message is added to that queue, it may be minutes or even hours before that new message is accessed. As a result, even though the queue for that new message was just referenced, that new message should be considered as a candidate for removal from main memory when the system is memory constrained. While sweeping messages from queues on the basis of most-recently referenced works in the previous example of a large queue containing 50,000 messages, it fails in the case of a small queue (e.g., containing 10 messages that were all recently added) as all of those messages are likely to be dequeued in the near future. Lastly, sweeping a queue having the greatest message depth first fails to understand that different queues can be dequeued at different rates. For example, assume queue 1 contains 10,000 messages and has a message dequeue rate of 1,000 messages per second and queue 2 contains 1,000 messages and has a message dequeue rate of 10 messages per second. If queue 1 is swept for having the greater message queue depth, then the application dequeuing queue 1 will be unfairly penalized because queue 1 only has 10 seconds worth of messages present, whereas queue 2 has 100 seconds worth of messages present.

Illustrative embodiments sweep message queues based on application usage patterns (e.g., queue utilization statistics) and queue properties relative to the other queues present on the same computer system to dynamically determine and adjust the swept message region or window of the queues and manage a greater number of messages than the physical main memory can support. Additionally, utilizing the same insights, illustrative embodiments can unsweep messages (i.e., move messages back onto queues in main memory from secondary persistent storage) ahead of predicted application demand. To maintain high throughput and not impact application performance (e.g., processing transactions) or computer system performance, illustrative embodiments should avoid the situation where an application wants to consume the next message, but that message is not resident in main memory, causing delays in bringing that message back into main memory from secondary persistent storage. The logic that illustrative embodiments utilize to evaluate the states of the different queues in main memory and take action to sweep messages, unsweep messages, or both is a combination of coded rules and machine learning. The queue state evaluation component of illustrative embodiments takes into account a plurality of different factors, such as, for example, message dequeue rate (i.e., the rate at which one or more applications consume messages from a queue), message enqueue rate (i.e., the rate at which one or more applications generate and add messages to a queue), message size, queue type (e.g., local queue with messages intended to be consumed by applications residing on the same computer system or transmission queue with messages destined for transfer to a remote node), message type (e.g., persistent message type or nonpersistent message type), time of day, and the like, for determining the number of messages to sweep and unsweep from a particular queue.

By examining application usage patterns and queue characteristics (i.e., the plurality of factors) across the message queues rather than trying to infer information as current message queueing middleware solutions do using statistical proxies, such as, for example, recently referenced or largest-first, a message queueing middleware managing its own memory utilizing illustrative embodiments can intelligently determine which messages in a queue are not currently needed by an application (i.e., candidates to be swept to secondary persistent storage), while also predicting which messages need to be unswept or restored to main memory from secondary persistent storage. By retaining in memory and restoring from secondary persistent storage only those messages which one or more applications will soon need (i.e., consume), illustrative embodiments reduce the risk of message thrashing. As a result, illustrative embodiments decrease transaction processing latency of applications and increase throughput of the computer system without unnecessarily consuming main memory resources. However, it should be noted that illustrative embodiments manage the sweeping and unsweeping of messages entirely outside the applications' awareness, which means illustrative embodiments do not need any application changes to be made, while still decreasing latency and increasing throughput.

Assume local applications on a computer system utilize message queueing middleware and a plurality of message queues, with some messages consumed by the local applications on that computer system and some messages being sent to a set of external nodes to be consumed by a set of remote applications. It should be noted that applications consume messages sequentially, which means that whenever an application consumes a message (i.e., dequeues or removes a message from a queue), the oldest message on that queue is consumed. As messages are enqueued to and dequeued from message queues, illustrative embodiments regularly monitor (e.g., on a defined time interval basis) the utilization of main memory by the message queueing middleware.

Upon detecting main memory utilization greater than a user-defined maximum memory utilization threshold level or its likely occurrence in the near future, illustrative embodiments evaluate the state of all queues in main memory to determine the contiguous range of messages, if any, that should be swept (i.e., removed) from main memory for each respective queue. The contiguous range of messages to be swept from main memory may be thought of as an adjustable swept message region or sliding window within a queue, with a reserved message buffer region of the oldest messages retained in main memory at the front of the queue to be consumed by local applications or to be sent over a network to be placed on a remote queue of a remote node for consumption by a remote application.

At the same time that illustrative embodiments are determining whether the adjustable swept message region of a queue needs to be adjusted (e.g., increased or decreased) in either direction, illustrative embodiments also predict whether messages need to be unswept from secondary persistent storage and restored onto main memory in a location at an end of the front reserved message buffer region of the queue containing the oldest messages, ahead of when an application will need those messages, thereby decreasing a front portion of the adjustable swept message region as a consequence. Illustrative embodiments stay ahead of application demand for consuming messages while decreasing memory utilization to prevent an out of memory error situation (i.e., main memory is full), which if such an error were allowed to occur, would negatively impact application and computer system performance.

The queue state evaluation component of illustrative embodiments utilizes both coded rules and a machine learning model. The coded rules include statically encoded rules that determine when to adjust (e.g., expand and contract) the adjustable swept message region or sliding window of a particular queue of a set of queues in main memory of the computer system. Utilizing coded rules ensures some kind of response to situations that need illustrative embodiments to take action (e.g., sweep messages from main memory to secondary persistent storage or unsweep messages from secondary persistent storage to main memory). Typically, the coded rules include, for example, a set of maximum memory utilization threshold levels and ideal targets, such as a desired buffer of messages present on the fronts of queues proportional to the rates of message dequeuing and the like. However, coded rules are limited to only covering application queue usage patterns that the developer can anticipate. In addition, coded rules may not be able to react quickly enough in certain situations.

The queue state evaluation component of illustrative embodiments utilizes the machine learning model to recognize complex application queue usage patterns, which are otherwise impractical or impossible to code into rules, to adjust the adjustable swept message region of a particular queue. By being able to recognize complex application queue usage patterns, the machine learning model can predict when to sweep messages out of a particular queue and when to unsweep messages back onto that particular queue in advance of actual application need. However, the machine learning model needs a large amount of data for training and testing and needs time and computational resources for training and testing. In addition, despite thorough training of the machine learning model, novel situations may still arise that the machine learning model cannot account for.

Using the combination of coded rules and machine learning, the queue state evaluation component of illustrative embodiments is capable of utilizing the strengths of both the coded rules and machine learning while addressing their individual weaknesses. For example, coded rules provide a foundational, real-time response to isolated events, such as, for example, remote node outages, network issues, application workload surges, and the like, and generate data that illustrative embodiments can utilize to further train the machine learning model. After training, the machine learning model can manage complex application queue usage patterns that cannot be coded into rules. Moreover, the queue state evaluation component of illustrative embodiments utilizes a plurality of factors including, for example, any combination of specific queue usage patterns (e.g., queue usage statistics by one or more applications), environmental factors (e.g., message processing either by the local computer system or by a remote node), and historical occurrences, including, but not limited to, message dequeue rate, message queue depth, average message size, message enqueue rate, time of day, time of last remote node outage, amount of network bandwidth utilization, predicted time of next remote node maintenance, historic maximum queue size, and the like.

For the purpose of exemplifying one possible illustrative embodiment, assume the queue state evaluation component of illustrative embodiments utilizes the coded rules, machine learning, and the plurality of factors to monitor the state of respective message queues on a regular 1-second time interval basis. Also, assume that the coded rules focus on the average message size and current queue depth of each particular queue, along with that particular queue's maximum observed 1-second dequeue rate over a period of time, such as, for example, the last 24 hours. Further, assume that when main memory is constrained causing illustrative embodiments to take action, illustrative embodiments try to maintain a number of oldest messages equivalent to, for example, at most 15 dequeue-rate-seconds worth of messages in the reserved message buffer region located at the front of the queue. However, it should be noted that this example 15 seconds worth of oldest messages in the reserved message buffer region may be too large or too small depending upon the configuration and needs of a particular environment (e.g., the local computer system or remote node). Therefore, illustrative embodiments can automatically select whatever time value is appropriate for that particular environment. For example, if decreasing the number of messages to 15 dequeue-rate-seconds per queue in main memory will still leave the main memory in a memory constrained state (e.g., still in danger of running out of memory), then illustrative embodiments recalculate how many messages to sweep out of main memory to secondary persistent storage using lower dequeue-rate-seconds, such as, for example, 10, 8, 5, 3, or the like, per queue until illustrative embodiments are able to maintain a desired amount of available main memory.

It should be noted that the number of messages to keep varies for each particular queue in main memory. For example, if queue 1 is consuming 20 messages per second and queue 2 is consuming 200 messages per second, illustrative embodiments try to keep 10 times more messages in main memory for queue 2 as compared to queue 1. However, it should be noted that some queues may not have many messages contained therein. For example, even though illustrative embodiments may try to keep 15 seconds worth of messages in memory for a particular queue, if only 3 seconds worth of messages exist on that particular queue, then illustrative embodiments only keep 3 seconds worth of messages in main memory for that particular queue because that is all the messages that exist for that particular queue.

Thus, illustrative embodiments provide one or more technical solutions that overcome a technical problem with an inability of current message queueing middleware solutions to proactively unsweep and sweep messages on queues in an intelligently predictive fashion to increase overall application and computer system performance. As a result, these one or more technical solutions provide a technical effect and practical application in the field of message queueing middleware.

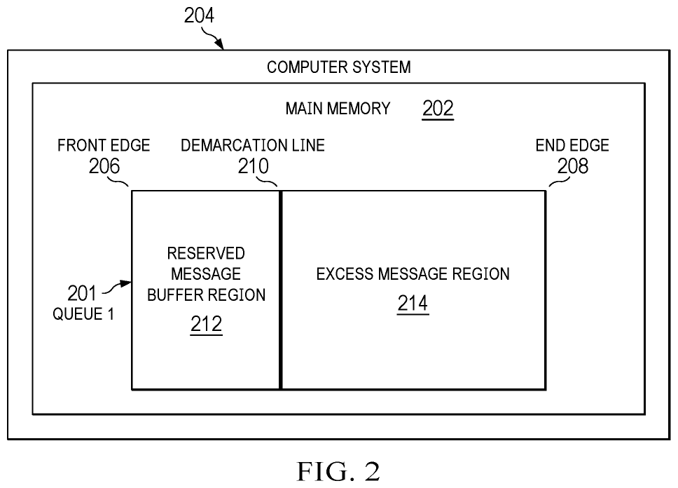

With reference now to FIG. 2, a diagram illustrating an example of a single message queue is depicted in accordance with an illustrative embodiment. In this example, queue 1 201 currently has all of its messages located in main memory 202 of computer system 204. Computer system 204 and main memory 202 may be, for example, computer 101 and volatile memory 112 in FIG. 1.

Queue 1 201 includes front edge 206 and end edge 208. Demarcation line 210 represents a separation between a number of messages that computer system 204 determines are soon needed messages by at least one application located to the left of demarcation line 210 in reserved message buffer region 212 containing the oldest messages, from those messages located to the right of demarcation line 210 in excess message region 214 that computer system 204 determines are excessive messages not needed in the near future by one or more applications. In other words, demarcation line 210 represents the rate of message dequeuing from queue 1 201 by those one or more applications. An understanding of how many messages are determined to be excessive in combination with the average message size enables a queue state evaluation component of computer system 204 to determine how queue 1 201 contributes to the overall utilization of main memory 202.

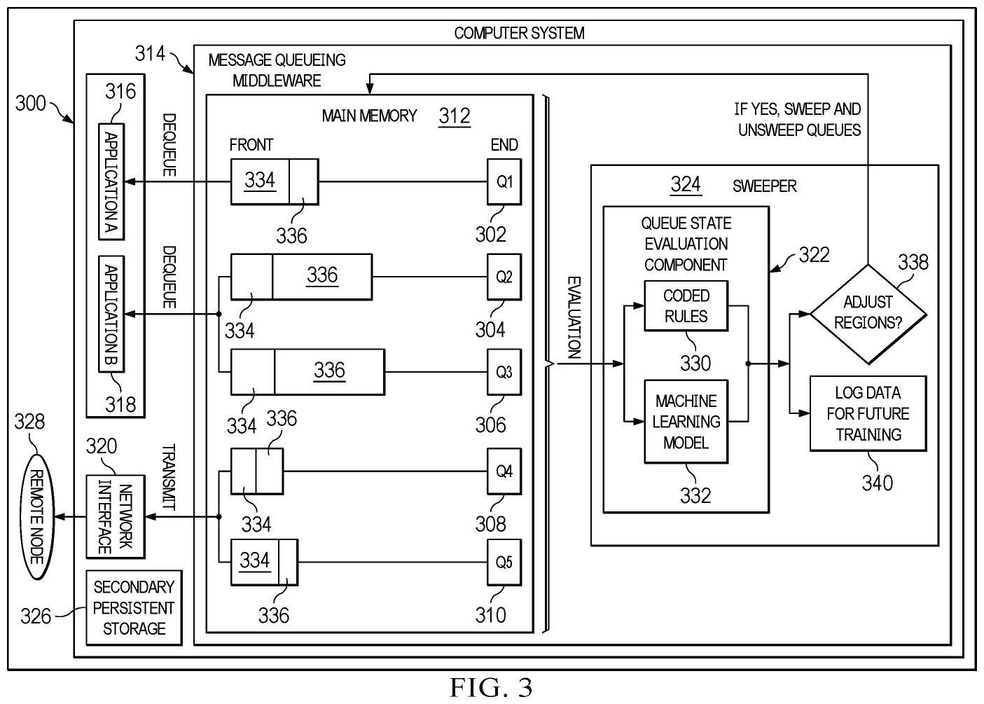

With reference now to FIG. 3, a diagram illustrating an example of a computer system with multiple message queues is depicted in accordance with an illustrative embodiment. In this example, computer system 300 includes queue Q1 302, queue Q2 304, queue Q3 306, queue Q4 308, and queue Q5 310 located in main memory 312. However, it should be noted that computer system 300 can include any number of queues (e.g., more or fewer queues than shown). Computer system 300 and main memory 312 may be, for example, computer 101 and volatile memory 112 in FIG. 1.

Computer system 300 also includes, for example, message queueing middleware 314, application A 316, application B 318, network interface 320, queue state evaluation component 322, sweeper 324, and secondary persistent storage 326. In this example, application A 316 locally consumes messages from queue Q1 302, and application B 318 locally consumes messages from queue Q2 304 and queue Q3 306. In addition, queue Q4 308 and queue Q5 310 transmit outbound messages to remote node 328 via network interface 320. It should be noted that inbound messages and enqueues are not depicted but are occurring, nonetheless. Further, it should be noted that in this example queue Q1 302, queue Q2 304, queue Q3 306, queue Q4 308, and queue Q5 310 of computer system 300 are all in a normal state in which each message is at least resident in memory.

Demarcation lines, such as, for example, demarcation line 210 in FIG. 2, are shown to indicate how queue state evaluation component 322, using at least one of coded rules 330 and machine learning model 332, would determine needed messages for reserved message buffer region 334 from excess messages in excess message region 336. However, because computer system 300 is not in a low memory state, sweeper 324, which is responsible for message sweeping and message unsweeping of queue Q1 302, queue Q2 304, queue Q3 306, queue Q4 308, and queue Q5 310, is currently inactive. For example, at 338, queue state evaluation component 322, using at least one of coded rules 330 and machine learning model 332, determines that adjusting the regions by sweeping and unsweeping of queue Q1 302, queue Q2 304, queue Q3 306, queue Q4 308, and queue Q5 310 is not needed. Afterward, at 340, queue state evaluation component 322 logs the data regarding the determination for future training of machine learning model 332.

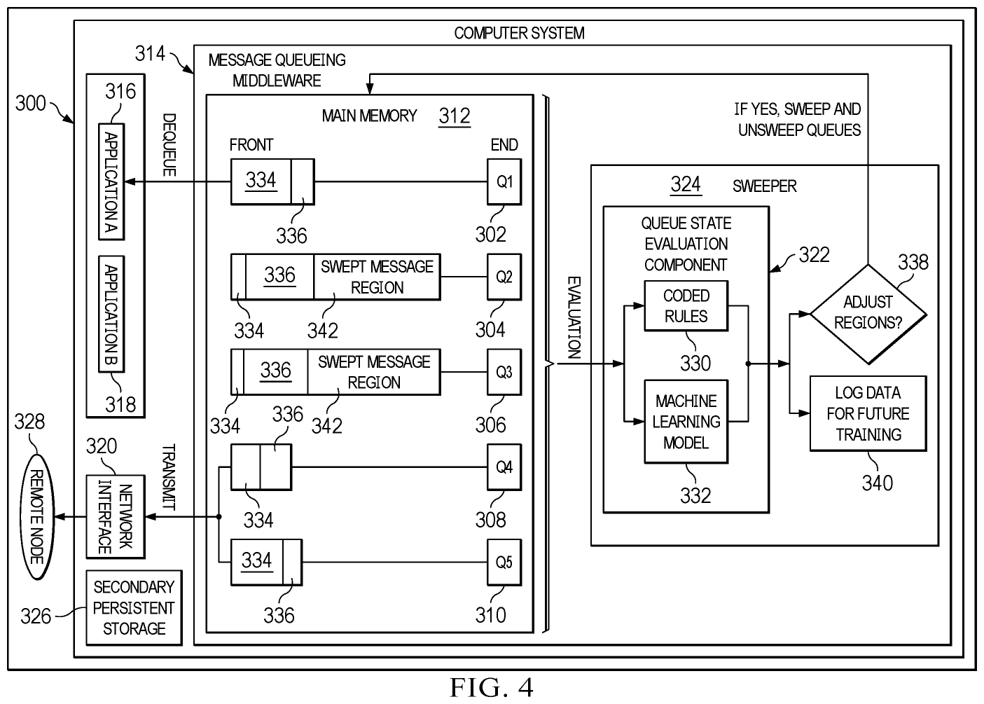

With reference now to FIG. 4, a diagram illustrating an example of a state of the computer system when an application stops processing messages is depicted in accordance with an illustrative embodiment. FIG. 4 depicts the state of computer system 300 after application B 318 has stopped processing messages off queue Q2 304 and queue Q3 306 while inbound messages continue to arrive on queue Q2 304 and queue Q3 306. As the queue depth grows on queue Q2 304 and queue Q3 306 and the dequeue rate of application B 318 drops to zero, queue state evaluation component 322 determines to move the demarcation lines, such as, for example, demarcation line 210 in FIG. 2, toward the front of queue Q2 304 and queue Q3 306, decreasing the number of messages considered needed for application B 318 in reserved message buffer region 334 and increasing the number of messages considered excess in excess message region 336. Queue state evaluation component 322, using coded rules 330, evaluates the states of queue Q2 304 and queue Q3 306 and, at 338, determines that sweeper 324 needs to sweep the contiguous block of messages in swept message region 342 on queue Q2 304 and queue Q3 306 to secondary persistent storage 326. Also, sweeper 234 will also sweep any new inbound messages that arrive on an already swept queue, which includes queue Q2 304 and queue Q3 306 in this example. At 340, queue state evaluation component 322 logs the data (e.g., the plurality of factors) used to evaluate queue Q2 304 and queue Q3 306 and the resultant determination as future training data for machine learning model 332.

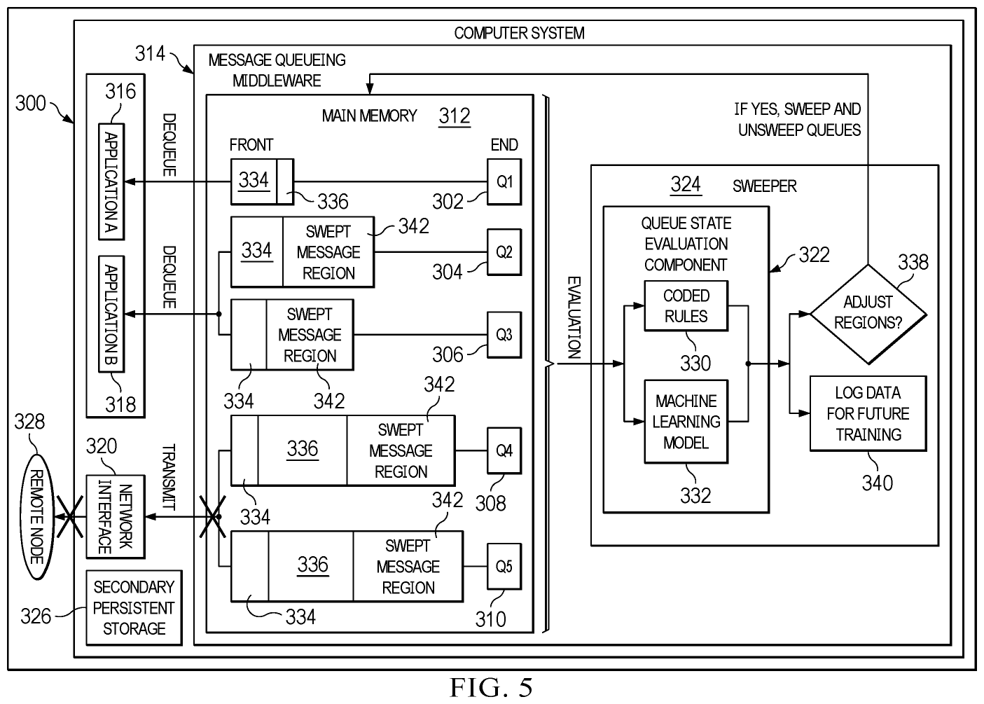

With reference now to FIG. 5, a diagram illustrating an example of a state of the computer system during a remote node outage is depicted in accordance with an illustrative embodiment. FIG. 5 depicts the state of computer system 300 after queue Q4 308 and queue Q5 310 are no longer transmitting messages via network interface 320 across the network due to an outage of remote node 328. However, it should be noted that in this example application B 318 is once again processing messages of queue Q2 304 and queue Q3 306.

Queue state evaluation component 322, using at least one of coded rules 330 and machine learning model 332, determines that queue Q2 304 and queue Q3 306 now have an insufficient number of needed messages in reserved message buffer region 334, while also determining that queue Q4 308 and queue Q5 310 have too many messages considering their zero dequeue rates due to the outage of remote node 328. As a result, queue state evaluation component 322 directs sweeper 324 to unsweep messages from secondary persistent storage 326 onto queue Q2 304 and queue Q3 306 while also directing sweeper 234 to sweep messages from queue Q4 308 and queue Q5 310 to secondary persistent storage 326. It should be noted that queue state evaluation component 322 directs sweeper 324 to perform the unsweeping of messages to queue Q2 304 and queue Q3 306 in anticipation of the predicted demand for those messages by application B 318, avoiding any negative impact on latency or throughput.

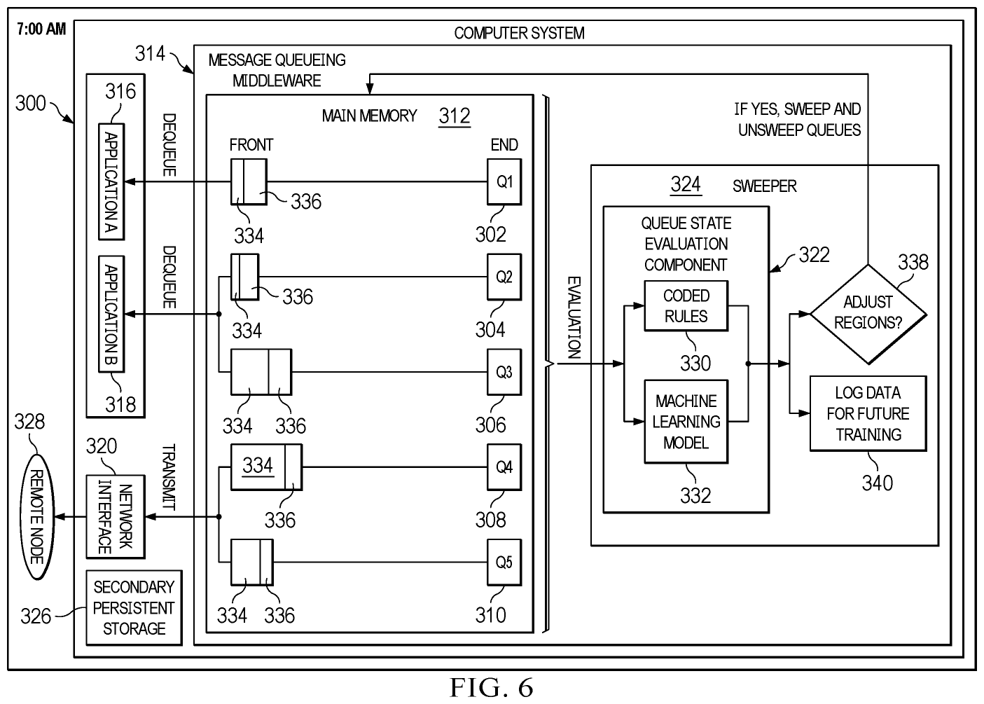

With reference now to FIG. 6, a diagram illustrating an example of a state of the computer system at a particular point in time during the day is depicted in accordance with an illustrative embodiment. FIG. 6 depicts the state of computer system 300 at 7:00 AM when normal operational state has returned after all messages swept from queue Q2 304, queue Q3 306, queue Q4 308, and queue Q5 310 in the example of FIG. 5 have been unswept from secondary persistent storage 326 back onto queue Q2 304, queue Q3 306, queue Q4 308, and queue Q5 310 and then dequeued and processed by application B 318 and remote node 328.

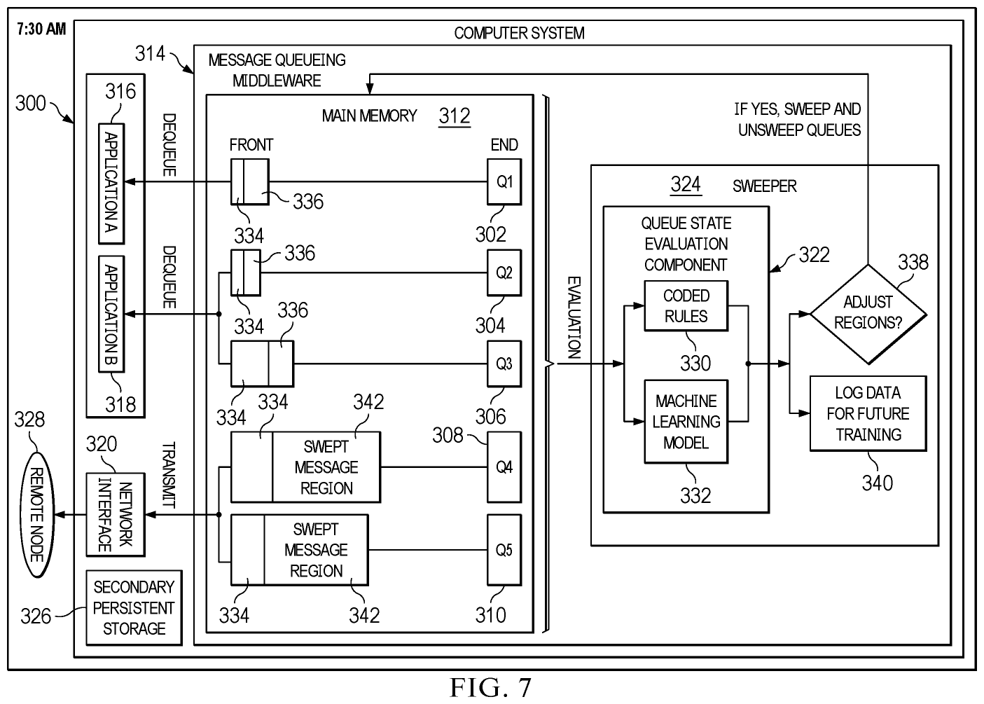

With reference now to FIG. 7, a diagram illustrating an example of a state of the computer system at a further point in time during the day is depicted in accordance with an illustrative embodiment. FIG. 7 depicts the state of computer system 300 at 7:30 AM, which is thirty minutes later than the example shown in FIG. 6.

In this example, remote node 328 has constrained processing capacity causing queue Q4 308 and queue Q5 310 to increase in size due to a decreased dequeue rate by remote node 328. However, the decreased dequeue rate is not enough to utilize more of main memory 312 above the maximum memory utilization threshold level to cause queue state evaluation component to trigger coded rules 330 into action. For example, assume queue Q4 308 and queue Q5 310 have an enqueue rate of 220 messages per second and remote node 328 can only process 200 messages per second causing queue Q4 308 and queue Q5 310 to grow in size. However, based on training using logged data at 340, machine learning model 332 of queue state evaluation component 322 has learned that around 8:00 AM every day queue Q4 308 and queue Q5 310 have an increased enqueue rate. As a result, machine learning model 332 directs sweeper 324 to proactively start sweeping messages from swept message region 342 of queue Q4 308 and queue Q5 310 to secondary persistent storage 326 to avoid high utilization of main memory 312 in the near future.

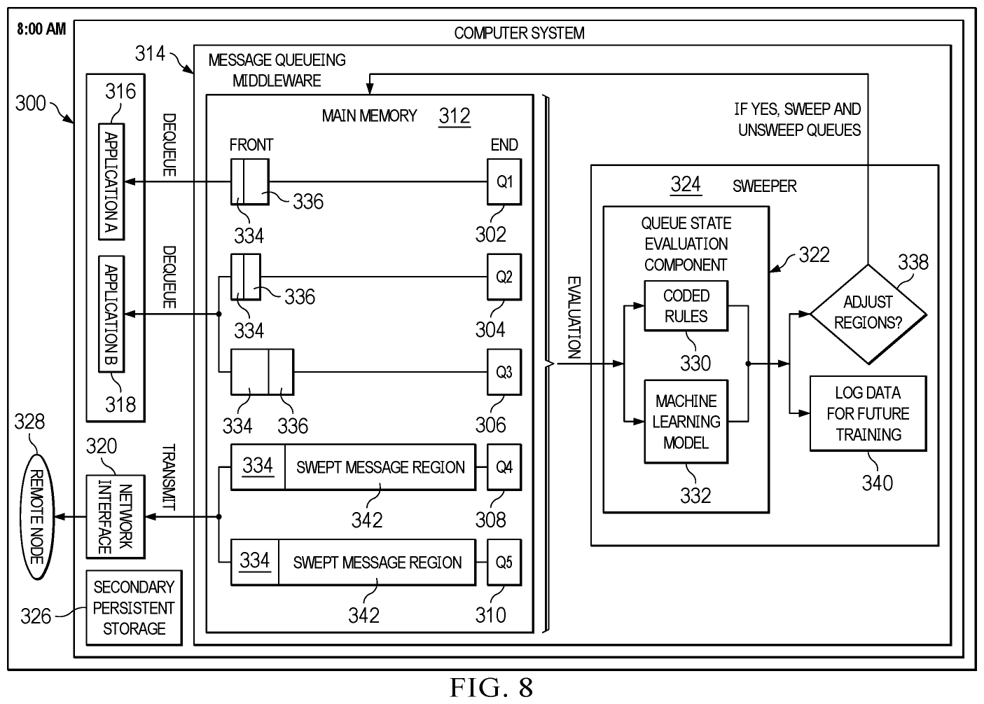

With reference now to FIG. 8, a diagram illustrating an example of a state of the computer system at yet a further point in time during the day is depicted in accordance with an illustrative embodiment. FIG. 8 depicts the state of computer system 300 at 8:00 AM when machine learning model 332 predicted an increase in the message enqueue rate to queue Q4 308 and queue Q5 310. Based on that prediction, sweeper 324 proactively swept messages from swept message region 342 of queue Q4 308 and queue Q5 310 to decrease the utilization of main memory 312 to prevent memory exhaustion. However, it should be noted that if the determination to sweep messages was based solely on coded rules 330 without the prediction, then memory exhaustion may have resulted causing decreased performance or a total outage of computer system 300.

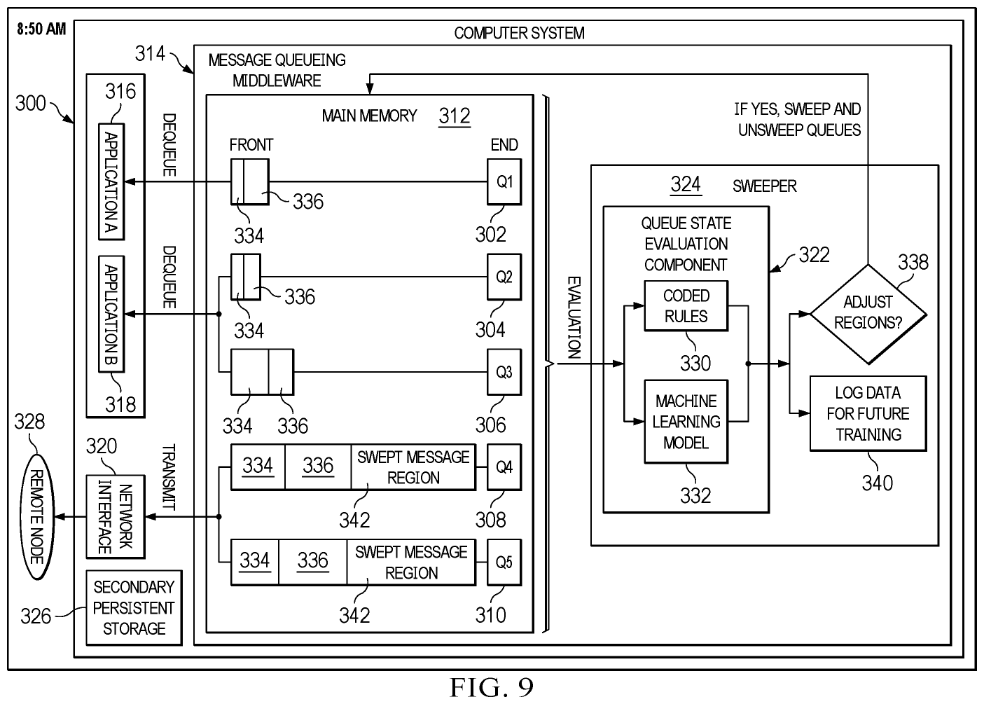

With reference now to FIG. 9, a diagram illustrating an example of a state of the computer system at yet another further point in time during the day is depicted in accordance with an illustrative embodiment. FIG. 9 depicts the state of computer system 300 regarding queue Q4 308 and queue Q5 310 at 8:50 AM, which is fifty minutes later than the example shown in FIG. 8. Machine learning model 332 has also learned that remote node 328 is restored to its full message processing capacity around 9:00 AM every day. For example, after remote node 328 completes a set of jobs between 8:00 and 8:50 AM, the rate at which remote node 328 processes inbound messages increases to 800 messages per second. To support the predicted increase in the message processing rate by remote node 328 at 9:00 AM, machine learning model 332 directs sweeper 324 to start proactively unsweeping messages from secondary persistent storage 326 onto queue Q4 308 and queue Q5 310.

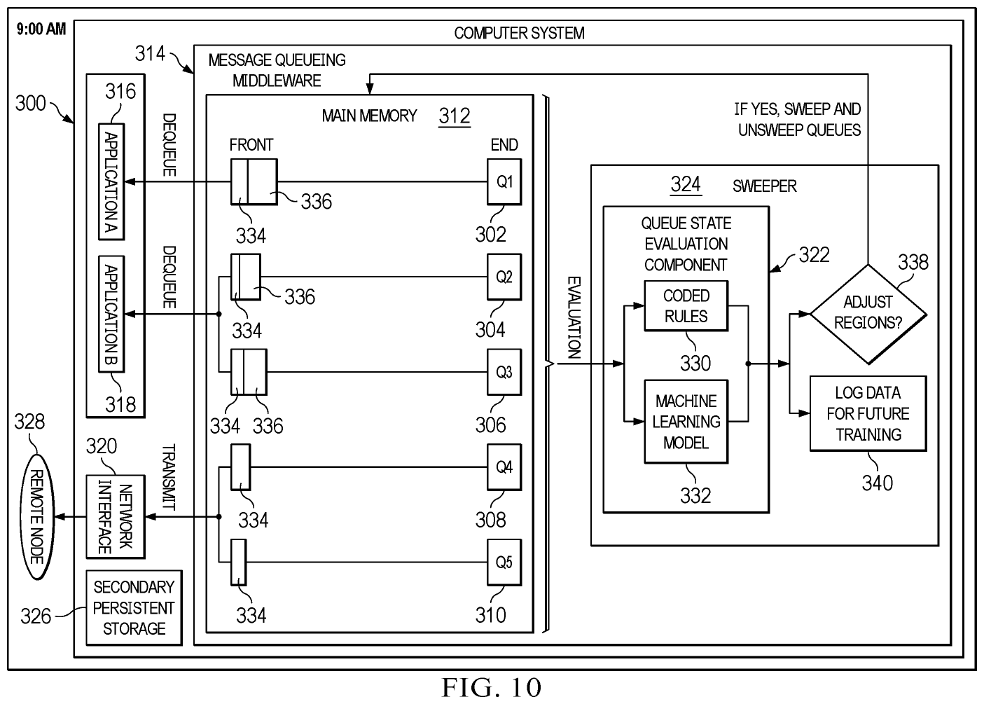

With reference now to FIG. 10, a diagram illustrating an example of a state of the computer system at yet still another further point in time during the day is depicted in accordance with an illustrative embodiment. FIG. 10 depicts the state of computer system 300 regarding queue Q4 308 and queue Q5 310 at 9:00 AM, which is ten minutes later than the example shown in FIG. 9. As predicted by machine learning model 332, queue Q4 308 and queue Q5 310 at 9:00 AM are now transmitting messages across the network at a significantly increased rate to remote node 328 via network interface 320. At this time, remote node 328 is now caught up and all previously swept messages from queue Q4 308 and queue Q5 310 have been unswept from secondary persistent storage 326 back onto queue Q4 308 and queue Q5 310 and processed by remote node 328.

In each of the examples of FIGS. 3-10 above, the queue state evaluation component of illustrative embodiments records the decisions made to sweep or unsweep the message queues and the data or information utilized to arrive at those decisions in a database, log, repository, or the like. The computer system can utilize the logged data to supplement or replace existing training data used to train the machine learning model of the queue state evaluation component, with the aim being to increase the predictive accuracy of the machine learning model in the future. Overall, the combination of machine learning and coded rules provides an adaptable queue state evaluation component.

Not illustrated in the examples above, but needed to keep illustrative embodiments as responsive as possible, additional paths should exist to drive message unsweeping from a queue upon increasing application demand, assuming neither the coded rules nor the machine learning model predicted the increase in activity. For example, in the case of a queue that has not been accessed in a long time (i.e., dequeue rate is 0) and has an insufficient buffer of messages to handle a sudden upswing in dequeues by the application, when the messages in the reserved message buffer are entirely consumed by the application and the application needs the next message, which is still swept on secondary persistent storage, unsweeping should begin immediately to meet the application demand rather than waiting for the current 1-second interval to elapse before the sweeper can unsweep messages back onto the queue. Similarly, if there is a somewhat larger, but still insufficient, buffer of messages and the application is dequeuing messages at a rate that will drain the buffer before the current 1-second interval expires, then unsweeping should begin to avoid running out of messages to return to the consuming application. Augmenting illustrative embodiments as such will help further ensure consistent latency and throughput even in these exemplified edge cases.

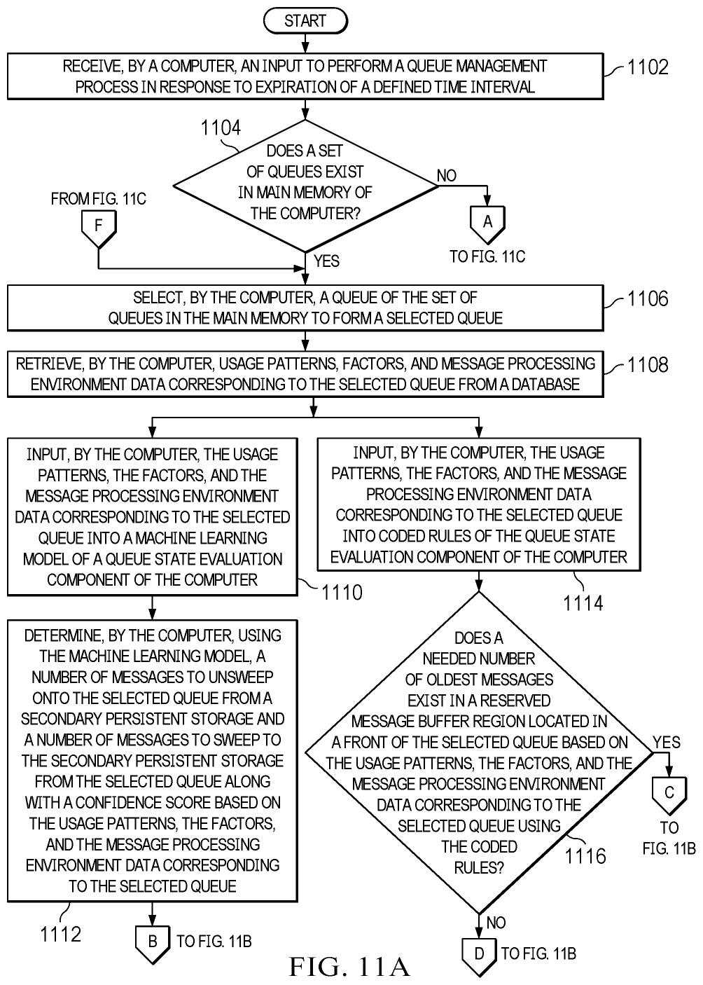

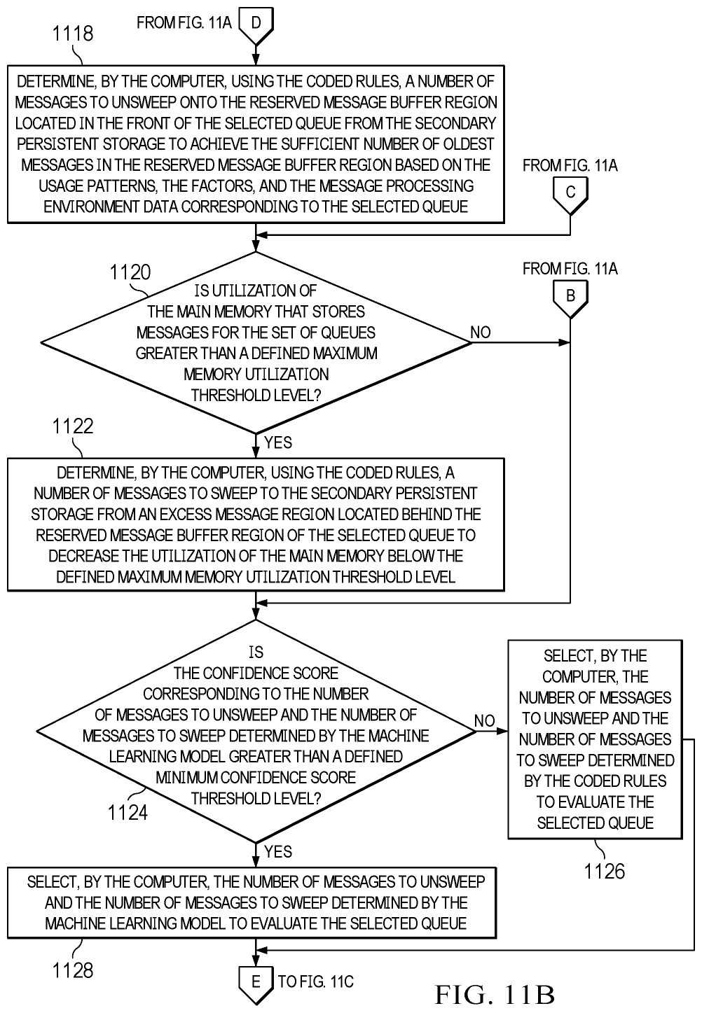

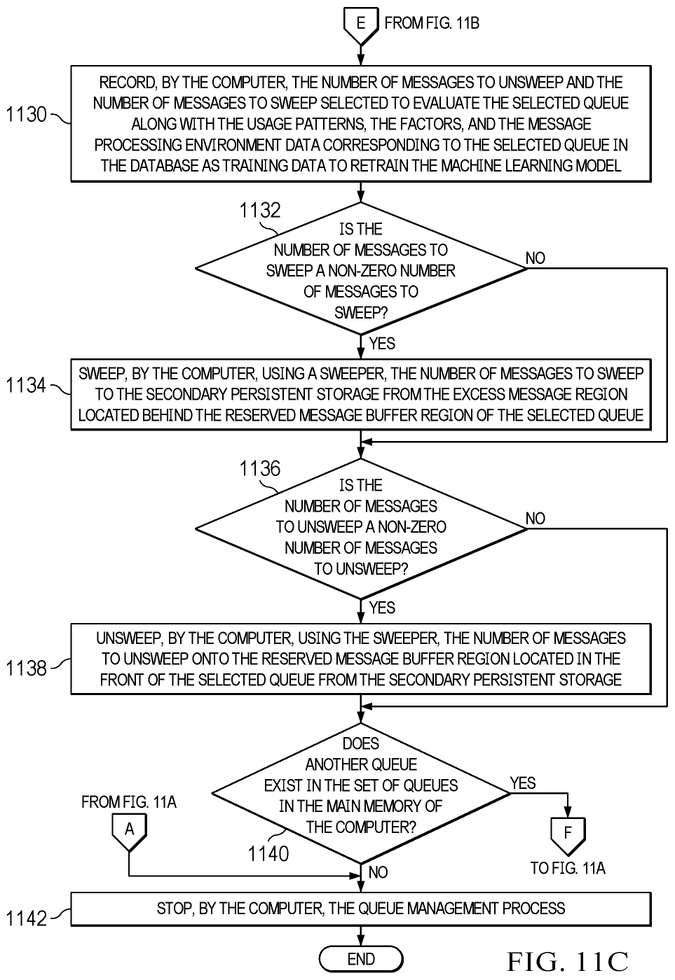

With reference now to FIGS. 11A-11C, a flowchart illustrating a process for managing message storage residency on queues is shown in accordance with an illustrative embodiment. The process shown in FIGS. 11A-11C may be implemented in a computer, such as, for example, computer 101 in FIG. 1. For example, the process shown in FIGS. 11A-11C may be implemented by queue management code 200 in FIG. 1.

The process begins when the computer receives an input to perform a queue management process in response to expiration of a defined time interval (step 1102). In response to receiving the input to perform the queue management process, the computer makes a determination as to whether a set of queues exist in main memory of the computer (step 1104). If the computer determines that a set of queues does not exist in the main memory of the computer, no output of step 1104, then the process proceeds to step 1142. If the computer determines that a set of queues does exist in the main memory of the computer, yes output of step 1104, then the computer selects a queue of the set of queues in the main memory to form a selected queue (step 1106).

Afterward, the computer retrieves usage patterns, factors, and message processing environment data corresponding to the selected queue from a database (step 1108). The usage patterns include, for example, when and how often one or more applications access that particular queue, such as message dequeue rate and message enqueue rate. The factors include, for example, message size, queue type, message type, time of day, and the like corresponding to that particular queue. The message processing environment data indicates whether the one or more applications consuming the messages from that particular queue are located locally on the computer or remotely on a remote node, for example.

The computer inputs the usage patterns, the factors, and the message processing environment data corresponding to the selected queue into a machine learning model of a queue state evaluation component of the computer (step 1110). The computer, using the machine learning model, determines a number of messages to unsweep onto the selected queue from a secondary persistent storage and a number of messages to sweep to the secondary persistent storage from the selected queue along with a confidence score based on the usage patterns, the factors, and the message processing environment data corresponding to the selected queue (step 1112). Thereafter, the process proceeds to step 1124.

Further, the computer concurrently with step 1110 inputs the usage patterns, the factors, and the message processing environment data corresponding to the selected queue into coded rules of the queue state evaluation component of the computer (step 1114). The computer makes a determination as to whether a needed number of oldest messages exist in a reserved message buffer region located in a front of the selected queue based on the usage patterns, the factors, and the message processing environment data corresponding to the selected queue using the coded rules (step 1116). If the computer determines that a needed number of oldest messages does exist in the reserved message buffer region located in the front of the selected queue based on the usage patterns, the factors, and the message processing environment data corresponding to the selected queue using the coded rules, yes output of step 1116, then the process proceeds to step 1120.

If the computer determines that a needed number of oldest messages does not exist in the reserved message buffer region located in the front of the selected queue based on the usage patterns, the factors, and the message processing environment data corresponding to the selected queue using the coded rules, no output of step 1116, then the computer, using the coded rules, determines a number of messages to unsweep onto the reserved message buffer region located in the front of the selected queue from the secondary persistent storage to achieve the needed number of oldest messages in the reserved message buffer region based on the usage patterns, the factors, and the message processing environment data corresponding to the selected queue (step 1118). In addition, the computer makes a determination as to whether utilization of the main memory that stores messages for the set of queues is greater than a defined maximum memory utilization threshold level (step 1120).

If the computer determines that the utilization of the main memory that stores messages for the set of queues is not greater than the defined maximum memory utilization threshold level, no output of step 1120, then the process proceeds to step 1124. If the computer determines that the utilization of the main memory that stores messages for the set of queues is greater than the defined maximum memory utilization threshold level, yes output of step 1120, then the computer, using the coded rules, determines a number of messages to sweep to the secondary persistent storage from an excess message region located behind the reserved message buffer region of the selected queue to decrease the utilization of the main memory below the defined maximum memory utilization threshold level (step 1122).

Further, the computer makes a determination as to whether the confidence score corresponding to the number of messages to unsweep and the number of messages to sweep determined by the machine learning model is greater than a defined minimum confidence score threshold level (step 1124). The defined minimum confidence score threshold level may be, for example, 70%, 75%, 80%, or the like. If the computer determines that the confidence score corresponding to the number of messages to unsweep and the number of messages to sweep determined by the machine learning model is not greater than the defined minimum confidence score threshold level, no output of step 1124, then the computer selects the number of messages to unsweep and the number of messages to sweep determined by the coded rules to evaluate the selected queue (step 1126). Thereafter, the process proceeds to step 1130. If the computer determines that the confidence score corresponding to the number of messages to unsweep and the number of messages to sweep determined by the machine learning model is greater than the defined minimum confidence score threshold level, yes output of step 1124, then the computer selects the number of messages to unsweep and the number of messages to sweep determined by the machine learning model to evaluate the selected queue (step 1128). However, it should be noted that alternative illustrative embodiments may not utilize confidence scores and thresholds to determine whether to utilize the number of messages to sweep and unsweep output by the machine learning model or output by the coded rules. For example, alternative illustrative embodiments may average the number of messages to sweep and unsweep output by the machine learning model and the coded rules and then utilize the average number of messages to sweep and unsweep to evaluate the queues.

Furthermore, the computer records the number of messages to unsweep and the number of messages to sweep selected to evaluate the selected queue along with the usage patterns, the factors, and the message processing environment data corresponding to the selected queue in the database as training data to retrain the machine learning model (step 1130). Afterward, the computer makes a determination as to whether the number of messages to sweep is a non-zero number of messages to sweep (step 1132). If the computer determines that the number of messages to sweep is not a non-zero number of messages to sweep, no output of step 1132, then the process proceeds to step 1136. If the computer determines that the number of messages to sweep is a non-zero number of messages to sweep, yes output of step 1132, then the computer, using a sweeper, sweeps the number of messages to sweep to the secondary persistent storage from the excess message region located behind the reserved message buffer region of the selected queue (step 1134).

Moreover, the computer makes a determination as to whether the number of messages to unsweep is a non-zero number of messages to unsweep (step 1136). If the computer determines that the number of messages to unsweep is not a non-zero number of messages to unsweep, no output of step 1136, then the process proceeds to step 1140. If the computer determines that the number of messages to unsweep is a non-zero number of messages to unsweep, yes output of step 1136, then the computer, using the sweeper, unsweeps the number of messages to unsweep onto the reserved message buffer region located in the front of the selected queue from the secondary persistent storage (step 1138).

Afterward, the computer makes a determination as to whether another queue exists in the set of queues in the main memory of the computer (step 1140). If the computer determines that another queue does exist in the set of queues in the main memory of the computer, yes output of step 1140, then the process returns to step 1106 where the computer selects another queue to evaluate. If the computer determines that another queue does not exist in the set of queues in the main memory of the computer, no output of step 1140, then the computer stops the queue management process (step 1142). Thereafter, the process terminates.

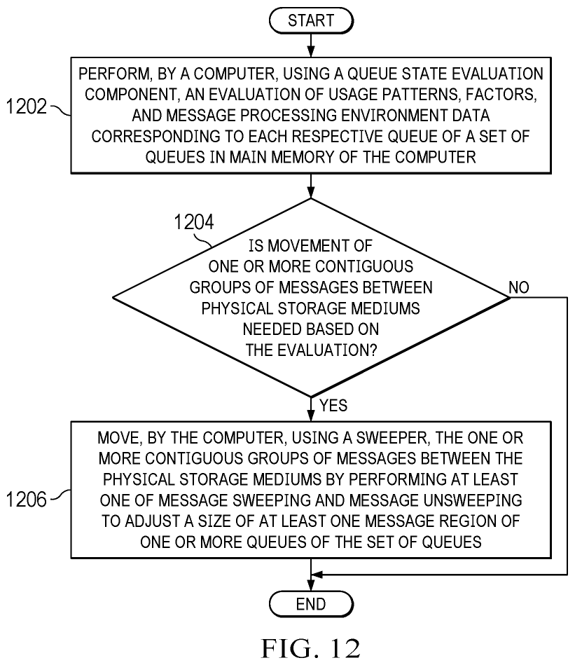

With reference now to FIG. 12, a flowchart illustrating a process for sweeping and unsweeping messages corresponding to queues on a macro scale is shown in accordance with an illustrative embodiment. The process shown in FIG. 12 may be implemented in a computer, such as, for example, computer 101 in FIG. 1. For example, the process shown in FIG. 12 may be implemented by queue management code 200 in FIG. 1.

The process begins when the computer, using a queue state evaluation component, performs an evaluation of usage patterns, factors, and message processing environment data corresponding to each respective queue of a set of queues in main memory of the computer (step 1202). The computer, using the queue state evaluation component, makes a determination as to whether movement of one or more contiguous groups of messages between physical storage mediums (i.e., between main memory and secondary persistent storage) is needed based on the evaluation of the usage patterns, the factors, and the message processing environment data corresponding to each respective queue of a set of queues in main memory of the computer (step 1204).

If the computer, using the queue state evaluation component, determines that the movement of one or more contiguous groups of messages between physical storage mediums is not needed based on the evaluation of the usage patterns, the factors, and the message processing environment data corresponding to each respective queue of a set of queues in main memory of the computer, no output of step 1204, then the process terminates thereafter. If the computer, using the queue state evaluation component, determines that the movement of the one or more contiguous groups of messages between the physical storage mediums is needed based on the evaluation of the usage patterns, the factors, and the message processing environment data corresponding to each respective queue of a set of queues in main memory of the computer, yes output of step 1204, then the computer, using a sweeper, moves the one or more contiguous groups of messages by performing at least one of message sweeping and message unsweeping to adjust a size of at least one message region of one or more queues of the set of queues (step 1206). Thereafter, the process terminates.

Thus, illustrative embodiments of the present disclosure provide a computer-implemented method, computer system, and computer program product for managing message storage residency on queues. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for managing message storage residency on queues, the computer-implemented method comprising:
performing, by a computer, an evaluation of usage patterns, factors, and message processing environment data corresponding to each respective queue of a set of queues in main memory; and
moving, by the computer, one or more contiguous groups of messages between physical storage mediums by performing at least one of message sweeping and message unsweeping to adjust a size of at least one message region of one or more queues of the set of queues in response to the computer determining that movement of the one or more contiguous groups of messages between the physical storage mediums is needed based on the evaluation.

2. The computer-implemented method of claim 1, further comprising:
selecting, by the computer, a queue of the set of queues in the main memory to form a selected queue; and
retrieving, by the computer, the usage patterns, the factors, and the message processing environment data corresponding to the selected queue from a database.

3. The computer-implemented method of claim 1, further comprising:
inputting, by the computer, the usage patterns, the factors, and the message processing environment data corresponding to a selected queue into a machine learning model of a queue state evaluation component; and
determining, by the computer, using the machine learning model, a number of messages to unsweep onto the selected queue from a secondary persistent storage and a number of messages to sweep to the secondary persistent storage from the selected queue along with a confidence score based on the usage patterns, the factors, and the message processing environment data corresponding to the selected queue.

4. The computer-implemented method of claim 3, further comprising:
determining, by the computer, whether the confidence score corresponding to the number of messages to unsweep and the number of messages to sweep determined by the machine learning model is greater than a defined minimum confidence score threshold level; and
selecting, by the computer, the number of messages to unsweep and the number of messages to sweep determined by the machine learning model to evaluate the selected queue in response to the computer determining that the confidence score corresponding to the number of messages to unsweep and the number of messages to sweep determined by the machine learning model is greater than the defined minimum confidence score threshold level.

5. The computer-implemented method of claim 1, further comprising:
inputting, by the computer, the usage patterns, the factors, and the message processing environment data corresponding to a selected queue into coded rules of a queue state evaluation component;
determining, by the computer, using the coded rules, whether a needed number of oldest messages exist in a reserved message buffer region located in a front of the selected queue based on the usage patterns, the factors, and the message processing environment data corresponding to the selected queue; and
determining, by the computer, using the coded rules, a number of messages to unsweep onto the reserved message buffer region located in the front of the selected queue from a secondary persistent storage to achieve the needed number of oldest messages in the reserved message buffer region based on the usage patterns, the factors, and the message processing environment data corresponding to the selected queue in response to the computer determining that the needed number of oldest messages does not exist in the reserved message buffer region located in the front of the selected queue.

6. The computer-implemented method of claim 5, further comprising:
determining, by the computer, whether utilization of the main memory that stores messages for the set of queues is greater than a defined maximum memory utilization threshold level; and
determining, by the computer, using the coded rules, a number of messages to sweep to the secondary persistent storage from an excess message region located behind the reserved message buffer region of the selected queue to decrease the utilization of the main memory below the defined maximum memory utilization threshold level in response to the computer determining that the utilization of the main memory that stores the messages for the set of queues is greater than the defined maximum memory utilization threshold level.

7. The computer-implemented method of claim 6, further comprising:
selecting, by the computer, the number of messages to unsweep and the number of messages to sweep determined by the coded rules to evaluate the selected queue in response to the computer determining that a confidence score corresponding to a number of messages to unsweep and a number of messages to sweep determined by a machine learning model is not greater than a defined minimum confidence score threshold level.

8. The computer-implemented method of claim 1, further comprising:
recording, by the computer, a number of messages to unsweep and a number of messages to sweep selected to evaluate a selected queue along with the usage patterns, the factors, and the message processing environment data corresponding to the selected queue in a database as training data to retrain a machine learning model;
determining, by the computer, whether the number of messages to sweep is a non- zero number of messages to sweep; and
sweeping, by the computer, the number of messages to sweep to a secondary persistent storage from an excess message region located behind a reserved message buffer region of the selected queue in response to the computer determining that the number of messages to sweep is a non-zero number of messages to sweep.

9. The computer-implemented method of claim 8, further comprising:
determining, by the computer, whether the number of messages to unsweep is a non-zero number of messages to unsweep in response to the computer determining that the number of messages to sweep is not a non-zero number of messages to sweep; and
unsweeping, by the computer, the number of messages to unsweep onto the reserved message buffer region located in a front of the selected queue from the secondary persistent storage in response to the computer determining that the number of messages to unsweep is a non-zero number of messages to unsweep.

10. The computer-implemented method of claim 1, wherein the usage patterns include message dequeue rate and message enqueue rate of a selected queue by one or more applications, and wherein the factors include message size, queue type, message type, and time of day corresponding to the selected queue, and wherein the message processing environment data indicate whether the one or more applications consuming messages from the selected queue are located locally on the computer or remotely on a remote node.

11. A computer system for managing message storage residency on queues, the computer system comprising:
a communication fabric;
a set of computer-readable storage media connected to the communication fabric, wherein the set of computer-readable storage media collectively stores program instructions; and
a set of processors connected to the communication fabric, wherein the set of processors executes the program instructions to:
perform an evaluation of usage patterns, factors, and message processing environment data corresponding to each respective queue of a set of queues in main memory; and
move one or more contiguous groups of messages between physical storage mediums by performing at least one of message sweeping and message unsweeping to adjust a size of at least one message region of one or more queues of the set of queues in response to determining that movement of the one or more contiguous groups of messages between the physical storage mediums is needed based on the evaluation.

12. The computer system of claim 11, wherein the set of processors further executes the program instructions to:
select a queue of the set of queues in the main memory to form a selected queue; and
retrieve the usage patterns, the factors, and the message processing environment data corresponding to the selected queue from a database.

13. The computer system of claim 11, wherein the set of processors further executes the program instructions to:
input the usage patterns, the factors, and the message processing environment data corresponding to a selected queue into a machine learning model of a queue state evaluation component;
determine, using the machine learning model, a number of messages to unsweep onto the selected queue from a secondary persistent storage and a number of messages to sweep to the secondary persistent storage from the selected queue along with a confidence score based on the usage patterns, the factors, and the message processing environment data corresponding to the selected queue;
input the usage patterns, the factors, and the message processing environment data corresponding to a selected queue into coded rules of the queue state evaluation component;
determine, using the coded rules, whether a needed number of oldest messages exist in a reserved message buffer region located in a front of the selected queue based on the usage patterns, the factors, and the message processing environment data corresponding to the selected queue; and
determine, using the coded rules, a number of messages to unsweep onto the reserved message buffer region located in the front of the selected queue from a secondary persistent storage to achieve the needed number of oldest messages in the reserved message buffer region based on the usage patterns, the factors, and the message processing environment data corresponding to the selected queue in response to determining that the needed number of oldest messages does not exist in the reserved message buffer region located in the front of the selected queue.

14. A computer program product for managing message storage residency on queues, the computer program product comprising a set of computer-readable storage media having program instructions collectively stored therein, the program instructions executable by a computer to cause the computer to:
perform an evaluation of usage patterns, factors, and message processing environment data corresponding to each respective queue of a set of queues in main memory; and
move one or more contiguous groups of messages between physical storage mediums by performing at least one of message sweeping and message unsweeping to adjust a size of at least one message region of one or more queues of the set of queues in response to determining that movement of the one or more contiguous groups of messages between the physical storage mediums is needed based on the evaluation.

15. The computer program product of claim 14, wherein the program instructions further cause the computer to:
select a queue of the set of queues in the main memory to form a selected queue; and
retrieve the usage patterns, the factors, and the message processing environment data corresponding to the selected queue from a database.

16. The computer program product of claim 14, wherein the program instructions further cause the computer to:
input the usage patterns, the factors, and the message processing environment data corresponding to a selected queue into a machine learning model of a queue state evaluation component; and
determine, using the machine learning model, a number of messages to unsweep onto the selected queue from a secondary persistent storage and a number of messages to sweep to the secondary persistent storage from the selected queue along with a confidence score based on the usage patterns, the factors, and the message processing environment data corresponding to the selected queue.

17. The computer program product of claim 16, wherein the program instructions further cause the computer to:
determine whether the confidence score corresponding to the number of messages to unsweep and the number of messages to sweep determined by the machine learning model is greater than a defined minimum confidence score threshold level; and
select the number of messages to unsweep and the number of messages to sweep determined by the machine learning model to evaluate the selected queue in response to determining that the confidence score corresponding to the number of messages to unsweep and the number of messages to sweep determined by the machine learning model is greater than the defined minimum confidence score threshold level.

18. The computer program product of claim 14, wherein the program instructions further cause the computer to:
input the usage patterns, the factors, and the message processing environment data corresponding to a selected queue into coded rules of a queue state evaluation component;
determine, using the coded rules, whether a needed number of oldest messages exist in a reserved message buffer region located in a front of the selected queue based on the usage patterns, the factors, and the message processing environment data corresponding to the selected queue; and
determine, using the coded rules, a number of messages to unsweep onto the reserved message buffer region located in the front of the selected queue from a secondary persistent storage to achieve the needed number of oldest messages in the reserved message buffer region based on the usage patterns, the factors, and the message processing environment data corresponding to the selected queue in response to determining that the needed number of oldest messages does not exist in the reserved message buffer region located in the front of the selected queue.

19. The computer program product of claim 18, wherein the program instructions further cause the computer to:
determine whether utilization of the main memory that stores messages for the set of queues is greater than a defined maximum memory utilization threshold level; and
determine, using the coded rules, a number of messages to sweep to the secondary persistent storage from an excess message region located behind the reserved message buffer region of the selected queue to decrease the utilization of the main memory below the defined maximum memory utilization threshold level in response to determining that the utilization of the main memory that stores the messages for the set of queues is greater than the defined maximum memory utilization threshold level.

20. The computer program product of claim 19, wherein the program instructions further cause the computer to:
select the number of messages to unsweep and the number of messages to sweep determined by the coded rules to evaluate the selected queue in response to determining that a confidence score corresponding to a number of messages to unsweep and a number of messages to sweep determined by a machine learning model is not greater than a defined minimum confidence score threshold level.
